(19) United States
(12) Patent Application Publication
(10) Pub. No.: US 2007/0270211 A1
(43) Pub. Date: Nov. 22, 2007

(54) Menu System

(75) Inventor: Martin Paul Moshal, Gibraltar (ZA)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Waterleaf Limited

(21) Appl. No.: 10/572,717

(22) PCT Filed: Sep. 21, 2004
(86) PCT No.: PCT/IB04/03071

§ 371 Date: Apr. 19, 2007

(30) Foreign Application Priority Data
Sep. 22, 2003 (GB) 0322107.4

(51) Int. Cl. A63F 13/00

(52) U.S. Cl. 463/29

(57) ABSTRACT

A menu system includes a display means for displaying game data to a number of available casino games playable by a player at an online casino. The display means is switchable between an overview mode and a detailed mode. The game data relating to any game that is displayed in the detailed mode is a superset of corresponding game data displayed for the same game in the overview mode, and the available games for which game data is displayed in the overview mode being a subset of the available games for which game data is displayed in the detailed mode. The menu system includes a categorisation facility that is operable to categorise the number of available casino games playable by the player into a number of different game categories. The game data displayed by the display means is sorted by game category and the number of game categories in the detailed mode is greater than the number of game categories in the overview mode. The game categories in the overview mode include games that are preferred by the player, games that are recommended to the player for play, and games that are new to the online casino, while game categories in the detailed mode include jackpot games offered by the online casino, table games offered by the online casino, video poker games offered by the online casino, slot James offered by the online casino, games that are preferred by the player and games that are recommended to the player for play.

### FIELD OF THE INVENTION

This invention relates to a menu system and, more particularly, to a menu system that is operable by a player to select a game which the player wishes to play, from a list of available games. The invention extends to a method of operation of the menu system.

### BACKGROUND TO THE INVENTION

Menu selection systems are widely utilised in graphical user interfaces (“GUIs”) for online casinos. An online casino generally includes a gaming server and a client workstation remote from the gaming server and linked thereto by means of a communication network such as the Internet.

One or more casino games are executable at the instance of a player client of the online casino. Each game offered by the casino consists of a server process, which is executable in the gaming server, and a client process, which is executable in the client workstation. The server process generates, upon request of the client process, one or more random events upon which an outcome of the casino game depends. Such random events can correspond, for example, to the roll of a die, the spin of a roulette wheel or the deal of a playing card, depending on which particular casino game is being played by the player. The client process, on the other hand, presents to the player a simulation of the casino game being played. The client process also enables the player to place wagers on, and to control the progress of, the casino game, and displays to the player the outcome of the game as a function of the random events generated by the server process.

In order to communicate with the gaming server of the online casino, the computer workstation operates under control of a casino client interface program. The client interface program includes a menu subsystem that displays to the player a menu of casino games that are offered by the particular online casino. The player is then able to select any one of the games on offer that he wishes to play. When selecting a particular game for the first time, the casino client interface program causes a software program corresponding to the client process for that particular casino game to be downloaded from the gaming server to the computer workstation, where it is stored locally on a mass storage device such as a hard disk drive. Once downloaded, the player can then install the software program on the workstation. Once the client process for a particular casino game has been downloaded and installed in this manner, the casino game can be played without the necessity for a further download.

In one particular menu subsystem, a list of games that are available for play at an online casino is displayed to the player as an unstructured, tiled display of individual game display windows. Each game display window includes a name of a corresponding game, as well as salient details and rules associated with the game. Where a client process associated with a particular game has not yet been downloaded from the gaming server to the computer workstation, the corresponding game display window in the menu subsystem includes an icon that can be activated by the player to initiate a download of the corresponding client process from the gaming server to the computer workstation. Where there are more games available that can be simultaneously displayed by the computer workstation, the player is required to bring the respective game display windows of the remaining games into view by causing the display to scroll. This type of menu subsystem is disadvantageous as it is inflexible and inconvenient for the player to browse through in order to find and to select a casino game that he wishes to play.

In order to overcome these disadvantages, a menu subsystem has been developed in which the available casino games are categorised. A casino game may be categorised in more than one category. Data relating to any casino game is divided into primary and secondary game data, the former including a name of the casino game and a brief description of a type of the casino game, and the latter including the name of the casino game, the type of the casino game, a more detailed description of the nature of the casino game, a set of rules applicable to the casino game, and a status of the casino game. The status of the casino game is active when the casino game is ready for playing by the user, and inactive when the game is not ready for playing by the user. The game status is set to be inactive when a client process of the casino game has not previously been downloaded from a gaming server and stored locally on a storage device on the computer workstation, or when an updated version of the client process of the casino game is available on the gaming server and must be downloaded in order for the game to be played by the player.

The different game categories are displayable to the player as a series of tabbed categories, according to a display standard that is well known in the art. The user is able to view game data relating to all the casino games in any desired category by selecting a corresponding tab for that game category. The primary game data of all the casino games in a selected tabbed game category is displayed in a scrollable window on the display screen. When the primary game data of any particular casino game displayed in the scrollable window is brought into focus by means of a pointing device, the secondary game data corresponding to that particular game in the selected game category is displayed in an adjacent non-scrollable window.

The menu subsystem enables a player to make game selection in a reduced time relative to other known casino menu subsystems.

### OBJECT OF THE INVENTION

It is an object of this invention to provide a menu system, and a method of operation thereof that will, at least partially, exhibit increased functionality relative to prior art casino menu systems.

### SUMMARY OF THE INVENTION

In accordance with this invention there is provided a menu system that includes a display means instructable to display game data to a number of available casino games playable by a player at an online casino characterised in that

the display means is switchable between an overview mode and a detailed mode, the game data relating to any game that is displayed in the detailed mode being a superset of corresponding game data displayed for the same game in the overview mode, and the available games for which game data is displayed in the overview mode being a subset of the available games for which game data is displayed in the detailed mode.

Further features of the invention provide for the menu system to include a categorisation facility operable to categorise the number of available casino games playable by the player into a number of different game categories, for any one of the casino games to be categorisable into a plurality of different game categories, for game data displayed by the display means to be sorted by game category, for the number of game categories in the detailed mode to be greater than the number of game categories in the overview mode, for the game categories in the overview mode to include games that are preferred by the player, games that are recommended to the player for play, and games that are new to the online casino, and for the game categories in the detailed mode to include jackpot games offered by the online casino, table games offered by the online casino, video poker games offered by the online casino, slot games offered by the online casino, games that are preferred by the player and games that are recommended to the player for play.

Still further features of the invention provide for either one or both of the overview mode and the detailed mode to display a login means capable of initiating a login process to authenticate the player for play at the casino, for the login means to be a login icon activatable by the player, for the overview mode to display a switching means capable of switching the display means to the detailed mode and for the detailed mode to display a corresponding switching means capable of switching the display means to the overview mode, and for the switching means to be a switch icon activatable by the player.

Yet further features of the invention provide for the game data displayed for any game in the overview mode to include at least one attribute of the game, preferably the name of the game, for the game data displayed in the detailed mode to include a plurality of different attributes of the game, for the plurality of different attributes to include any two or more of the name of the casino game, a size of a jackpot that can be won on the casino game, a plurality of different parameters of the casino game, a graphical representation of the game display, and a game status, for the game status to be an active status when the casino game is ready for playing by the user, and an inactive status when the game is not ready for playing by the user, and for the game to be ready for playing by the user when the casino game has previously been downloaded from a gaming server.

Preferably, the display means displays, in the detailed mode, a plurality of categories of games as tabbed categories, for one or more predetermined attributes of all games in any tabbed category to be displayed by the display means in tabular columns in a scrollable window, and for all the attributes of any particular game to be displayed in an adjacent non-scrollable window when any attribute in the scrollable window is brought into focus by means of a pointing device.

There is further provided for the menu system to include a selection means activatable by the player to add and remove any one or more of the casino games to the category of casino games that are preferred by the player.

There is still further provided for the display means to be instructable to also display the game categories and the casino games in each category by means of a conventional fly-out menu display.

The invention extends to a method of operation of a menu system, including the step of displaying game data to a number of available casino games available for play by the player at an online casino

characterised in that

the displayed game data is switchable between an overview mode and a detailed mode, the game data relating to any game that is displayed in the detailed mode being a superset of corresponding game data displayed for the same game in the overview mode, and the available games for which game data is displayed in the overview mode being a subset of the available games for which game data is displayed in the detailed mode.

There is further provided for the method to include the further step of categorising the number of available casino games playable by the player into a number of different game categories, for selectively categorising any one of the casino games into a plurality of different game categories, for sorting displayed game data by game category, for displaying the game data in the detailed mode according to a greater number of game categories than in the overview mode, for displaying the game data in the overview mode according to at least the categories of games that are preferred by the player, games that are recommended to the player for play, and games that are new to the online casino, and for displaying the game data in the detailed mode by means of at least the categories of jackpot games offered by the online casino, table games offered by the online casino, video poker games offered by the online casino, slot games offered by the online casino, games that are preferred by the player and games that are recommended to the player for play.

There is still further provided for enabling the player to initiate, from both the overview mode and the detailed mode, a login process to authenticate the player for play at the casino, and for enabling the player to selectively switch the display of game data from the overview mode to the detailed mode and from the detailed mode to the overview mode.

There is yet further provided for including in the game data displayed for any game in the overview mode at least one attribute of the game, preferably the name of the game, for including in the game data for any game displayed in the detailed mode a plurality of attributes of the game, for the plurality of different attributes to include any two or more of the name of the casino game, a size of a jackpot that can be won on the casino game, a plurality of different parameters of the casino game, a graphical representation of the game display, and a game status, for setting the game status to be an active status when the casino game is ready for playing by the user, and an inactive status when the game is not ready for playing by the user, and for the game to be ready for playing by the user when the casino game has previously been downloaded from a gaming server.

Preferably, the method includes the step of displaying, in the detailed mode, a plurality of categories of games as tabbed categories, for displaying one or more predetermined attributes of all games in any tabbed category in tabular columns in a scrollable window, and for displaying all attributes of any particular game an adjacent non-scrollable window when any attribute of the same game in the scrollable window are brought into focus by means of a pointing device.

There is also provided for the method to include the further steps of:

adding any desired one or more of the available casino games to the category of casino games preferred by the player; and

removing any casino game from this category when the player no longer prefers it.

There is also provided for displaying the game categories and the casino games in each category by means of a conventional fly-out menu display.

### BRIEF DESCRIPTION OF THE DRAWINGS

A preferred embodiment of the invention is described below, by way of example only, and with reference to the abovementioned drawings, in which:

FIG. 1 is a schematic representation of a menu system according to the invention;

FIG. 2 is a display of game data displayed by the menu system of FIG. 1, in an overview mode; and

FIG. 3 is a display of game data displayed by the menu system of FIG. 1, in a detailed mode.

### DETAILED DESCRIPTION OF THE INVENTION

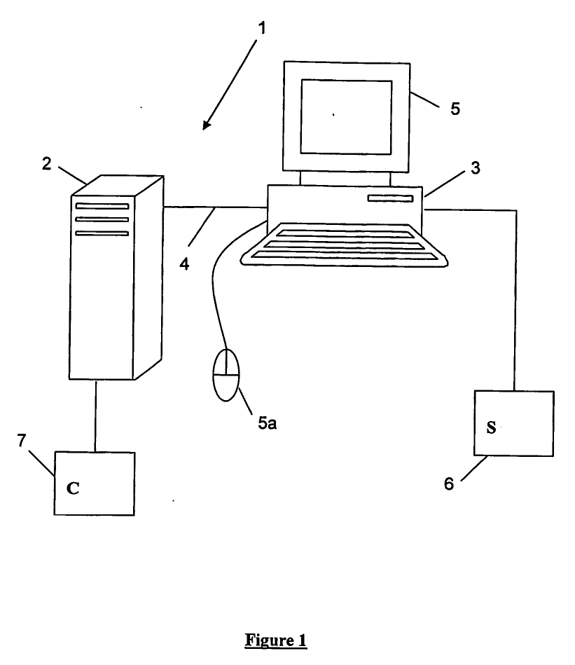

Referring to FIG. 1, a menu system is indicated generally by reference numeral (1).

The menu system (1) includes a gaming server (2) and a player access facility in the form of a computer workstation (3) with an associated display means (5) such as a display monitor, and a pointing device (5a) such as a mouse or, alternatively, a touchpad. The computer workstation (3) is located remotely from the gaming server (2) and communication between the computer workstation and the gaming server is provided by means of a communication network (4) that is, in this embodiment, the Internet.

The computer workstation (3) is a conventional personal computer operating under a Windows 2000 operating system, which is well known and commercially available from the Microsoft Corporation of Seattle, Wash., USA. The gaming server (2) operates under a Windows NT operating system. The computer workstation (3) operates under the control of a stored program (6), the operation of which will be outlined in the description that follows. Each casino game includes a client process (not shown) that is executable on the computer workstation (3) and a corresponding server process (not shown) that is executable on the gaming server (2). Each server process includes a random number generator that generates one or more random events that determine the outcome of the corresponding casino game. The client process obtains the result of the random event from the gaming server (2), across the communication network (4) and displays the outcome of the game on the display monitor (5) in an intelligible manner. The gaming server (2) can execute any one of a number of different casino games under instruction of a user through the computer workstation (3). In order to play any particular casino game, the corresponding client process for that game must be downloaded from the gaming server (2) to the computer workstation (3).

A menu system includes a categorisation facility (7) operable to categorise each one of the different casino games available on the gaming server (2) into one or more different categories. Examples of such categories include, for example, progressive jackpot games, table games, video poker games, slots games and new games that have not previously been accessible through the menu system. The categorisation also includes two further categories of casino games, namely favourites, which are games that are preferred by the player, and recommended games. The significance and function of these categories of casino games will be described below. Any casino game can be categorised into more than one different category. For example, a particular game may be classified as a video poker game, as well as being categorised as a game that is recommended to the user for play.

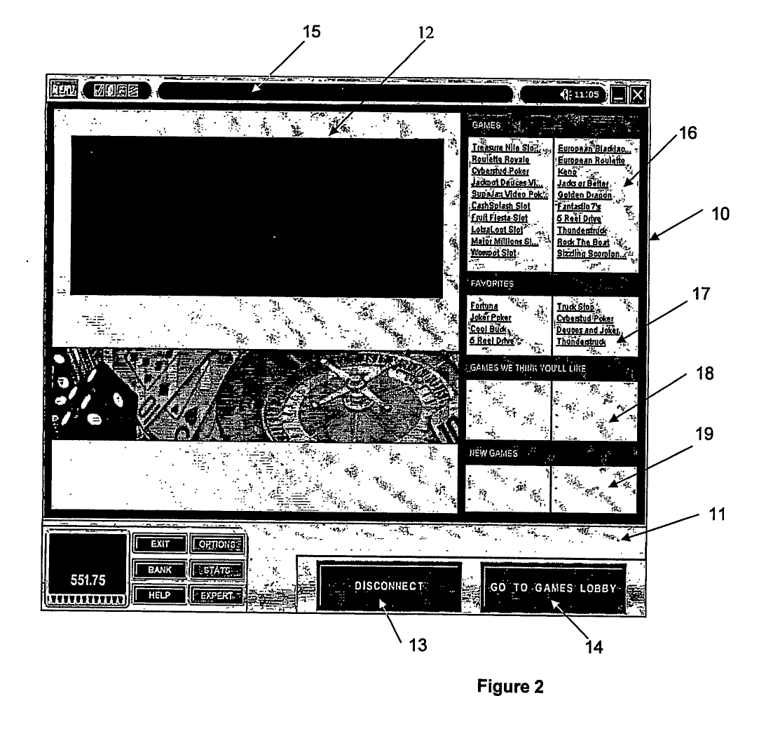

Execution of the stored program (6) of the computer workstation (3) displays to the player a display of game data by means of a home page (10), which corresponds to an overview mode, and a games lobby page (20), which corresponds to a detailed mode. The home page, which is a composite web page, is indicated in FIG. 2, and consists of a web page in the form of a standard frame (11), and a user-configurable web page (12) that is overlaid on the standard frame. An example of the composite home page is indicated in FIG. 2. An operator of the online casino can utilise the user-configurable web page (12) to present brand-specific promotional information to the player. The standard frame (11) displays the following information to the player:
an activatable icon (13) that opens a dialogue box which permits the player to complete a login procedure in order to play at the online casino or, when already logged in, to disconnect from the gaming server (2);
a navigation icon (14) that directs the player to a games lobby page, the operation of which will be described in detail in the description that follows;
a dialogue area (15) that is available to present configurable text messages to the player;
an unsorted list (16) of the names of a maximum of 20 most popular games available for play at the online casino;
an unsorted list (17) of the names of a maximum of 8 games that are preferred by the player (“Favourites”);
an unsorted list (18) of the names of a maximum of 8 games that are recommended to the player (“Recommendations”); and
an unsorted list (19) of the names of a maximum 6 games that are newly-accessible games offered by the online casino (“New Games”).

When the stored program (6) is executed for a first time after installation on the computer workstation (3), the latter three lists, namely Favourites (17), Recommendations (18) and New Games (19), on the player home page do not contain any entries. These lists are populated once the player logs in and connects to the gaming server (2). The contents of these lists are stored in a player registry (not shown) on the gaming server (2). The name of any game in a list is an active web link that can be used to directly invoke the game.

In use, the player can use the navigation icon (14) on the home page to navigate to the games lobby page (20). The games lobby page displays the games available for play at the casino in the following manner:
1. an activatable icon (13) that opens a dialogue box which permits the player to complete a login procedure in order to play at the online casino;
2. a navigation icon (21) that directs the player to the home page, the operation of which was described above;
3. a dialogue area (15) that is available to present configurable text messages to the player;
4. the Favourites list (17) which is identical to that displayed in the player home page;
5. the Recommendations list (18) which is identical to that displayed on the player home page;
6. a Games List in the form of a tabbed display (22) of all games available for play at the online casino; and
7. a game data window (23) that displays summary game data corresponding to a game that is highlighted in the Games List.

The tabs presented to the player in the Games List (22) correspond to the categories into which available casino games are categorised by the categorisation facility (7). When a particular category tab is highlighted, or brought into focus by means of the pointing device (5a), a list of all available casino games in that category is displayed as a list in a scrollable window (24).

When any game in the list is highlighted or brought into focus by means of the pointing device (5a), game data that describes and illustrates the particular game is displayed in the game data window (23).

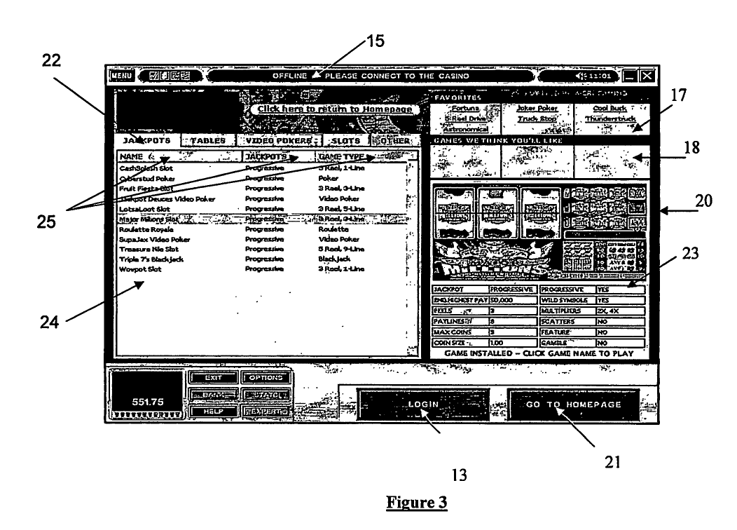

The games lobby page is illustrated in FIG. 3. The Games List (22) has five tabs, which are labelled Jackpots (games with a jackpot prize), Tables (for table games), Video Pokers, Slots and Other (for games that do not fit naturally into one of the other categories). Each game in a category is listed under multiple attributes. Corresponding attributes of all games in a particular game category are displayed in a column under a corresponding heading (25). Clicking on any particular heading (25) with the pointing device (5a) sorts the games in the list according to that attribute. Referring to FIG. 3, the Jackpots tab is highlighted, and visible attributes of games in this category are Name, Jackpots, and Game Type. One of the games, with a name of “Major Millions Slot” is highlighted in the list of games in this category. The other attributes of this game are that it is a progressive jackpot game, and that it is a 3-reel slot game with 3 pay lines.

While a particular game in the Games List (22) is highlighted, more detailed information about the game is displayed in the game data window (23). Those skilled in the art will appreciate that the type of detailed information displayed in the game data window will be dependent of the category in which the particular game has been classified. Again referring to FIG. 3, the game data window displays the following summary game data pertaining to the “Major Millions Slot” game:
a value of a highest, or jackpot, prize;
a value of a second-highest jackpot offered by the game;
a number of reels in the slots game;
a number of pay lines in the game;
a maximum number of points (or credits) accepted by the game;
a denomination (or coin size) of wagers placed on the game;
whether the game participates in a progressive jackpot;
whether the game includes wild symbols;
whether the game has a multiplier feature;
whether the game has a scatter symbol feature;
whether the game has any other particular feature;
a graphical representation of the game display; and
a game status.

Double clicking on any game listed in the Games List, the Favourites list or the Recommendations list in the games lobby page causes that game to open and to execute.

The stored program (6) tracks the playing history of a player and the games that appear in the Favourites list are determined to be the games that are most often played by the player. The games that appear in the Recommendations list are downloaded from the gaming server (2) when the player invokes the player home page for a second or subsequent time. The games in the Recommendations list can be configured manually by an operator of the online casino, or may be determined intelligently by an analysis of the player's playing history, or may, further, be made as a function of other parameters and information, such as a player-supplied profile of preferred games.

Numerous modifications are possible to this embodiment without departing from the scope of the invention. In particular, the stored program (6) of the computer workstation (3) may provide the player with a selection means that is operable by the player to add and remove any one or more of the games in any one of the tabbed game categories to the Favourites list. It will be appreciated by those skilled in the art that the player is thus able to configure the menu system (1) to provide for simple and rapid navigation to a subset of the available casino games on the gaming server (2) that are of particular interest to the user. Further, the different game categories, and the different games in each game category are also displayable by means of a conventional fly-out menu display, of a type that is well known in the Windows operating system from the Microsoft Corporation. The game data window displays to the player detailed game information corresponding to any particular game even when the game status of that particular game has been set to be inactive. This facility makes it possible for the user to make an informed decision, on the basis of this detailed game information thus displayed, as to which casino games to download from the entire library of casino games available on the gaming server (2).

It will be further appreciated by those skilled in the art that the categorisable menu system (1) described above will facilitate selection by a user of desirable casino games to download from a gaming server in order to play such games.

The technical problem solved by this invention is that of simplifying and speeding up the making of a selection from a menu of available choices. The use of configurable categories into which individual available choices may be categorised, together with the use of a specific category for personally preferred choices, and automatic pre-selection enables a user of the menu system to make a selection in a reduced time relative to prior art menu systems.

The invention therefore provides a menu system that provides a simple and convenient user interface for an on-line casino, and which is customisable by a user to enable rapid access to a subset of available casino games that are preferred by the user.

1-42. (canceled)

43. A menu system that includes display means operable to display game data corresponding to a number of available casino games playable by a player at an online casino, the number of available casino games being categorized into a plurality of different selectable game categories characterized in that the display means displays to the player, simultaneously:
a) an identity of each one of the plurality of different game categories;
b) at least one attribute of each game in any selected one of the plurality of different game categories; and
c) additional game attributes of any selected one of the games in the selected game category.

44. A menu system as claimed in claim 43 in which the at least one attribute displayed for each game in any selected one of the plurality of different game categories is a name of the game.

45. A menu system as claimed in claim 44 in which the additional game attributes displayed for any selected one of the games in the selected game category includes any one or more of a size of a jackpot that can be won on the casino game, a plurality of different parameters of the casino game, a graphical representation of a display of the game, and a game status.

46. A menu system as claimed in claim 45 in which the game status is an active status when the casino game is ready for playing by the player, and an inactive status when the game is not ready for playing by the player.

47. A menu system as claimed in claim 46 in which the game is ready for playing by the player when the casino game has previously been downloaded from a gaming server.

48. A menu system as claimed in claim 43 in which the display means displays the plurality of different game categories to the player as tabbed categories.

49. A menu system as claimed in claim 48 in which the display means displays the at least one attribute of each game in any selected one of the tabbed game categories in tabular column format in a scrollable window.

50. A menu system as claimed in claim 49 in which the display means displays simultaneously the additional game attributes for any selected one of the games in the selected one of the tabbed game categories in an adjacent non-scrollable window.

51. A menu system as claimed in claim 43 which includes a categorization facility operable to categorize the number of available casino games playable by the player into the plurality of different game categories.

52. A menu system as claimed in claim 51 in which the plurality of different game categories include games that are preferred by the player, games that are recommended by the online casino to the player for play, games that are new to the online casino, jackpot games offered by the online casino, table games offered by the online casino, video poker games offered by the online casino, and slots games offered by the online casino.

53. A menu system as claimed in claim 51 in which any one of the number of available casino games is categorizable into more than one different game category.

54. A menu system as claimed in claim 52 that includes a selection means activatable by the player to add and remove any one or more of the available casino games to the category of casino games preferred by the player.

55. A menu system as claimed in claim 48 in which the display means is operable to also display to the player the plurality of different game categories and the casino games in each category by means of a conventional fly-out menu.

56. A method of operation of a menu system for displaying game data corresponding to a number of available casino games playable by a player at an online casino, comprising the steps of:
categorizing the available casino games into a plurality of different selectable game categories; and
displaying to the player, simultaneously,
a) an identity of each one of the plurality of different game categories;
b) at least one attribute of each game in any selected one of the plurality of different game categories; and
c) additional game attributes of any selected one of the games in the selected game category.

57. A method as claimed in claim 56 that includes a step of displaying the at least one attribute for each game in any selected one of the plurality of different game categories as a name of the game.

58. A method as claimed in claim 57 that includes a step of displaying the additional game attributes for any selected one of the games in the selected game category to include any one or more of a size of a jackpot that can be won on the casino game, a plurality of different parameters of the casino game, a graphical representation of a display of the game, and a game status.

59. A method as claimed in claim 58 in which the game status is an active status when the casino game is ready for playing by the player, and an inactive status when the game is not ready for playing by the player.

60. A method as claimed in claim 59 in which the game is ready for playing by the player when the casino game has previously been downloaded from a gaming server.

61. A method as claimed in claim 56 in which the plurality of different game categories are displayed to the player as tabbed categories.

62. A method as claimed in claim 61 in which the at least one attribute of each game in any selected one of the tabbed game categories is displayed in tabular column format in a scrollable window.

63. A method as claimed in claim 62 in which the additional game attributes for any selected one of the games in the selected one of the tabbed game categories are displayed simultaneously in an adjacent non-scrollable window.

64. A method as claimed in claim 56 in which the available games are categorized into at least the following different game categories: games that are preferred by the player, games that are recommended by the online casino to the player for play, games that are new to the online casino, jackpot games offered by the casino, table games offered by the online casino, video poker games offered by the online casino, and slots games offered by the online casino.

65. A method as claimed in claim 56 in which any one of the number of available casino games is categorizable into more than one different game category.

66. A method as claimed in claim 64 that includes a step of enabling the player to optionally add and remove any one or more of the available casino games to the category of casino games preferred by the player.

67. A method as claimed in claim 61 in which the plurality of different game categories and the casino games in each category are also displayed to the player by means of a conventional fly-out menu.
